(19) United States
(12) Patent Application Publication
(10) Pub. No.: US 2024/0256289 A1
(43) Pub. Date: Aug. 1, 2024

(54) METHODS AND APPARATUS FOR FAST WAKE-UP VIA VIRTUALIZED ADDRESSES

(71) Applicant: GoPro, Inc., San Mateo, CA (US)

(72) Inventors: Gregory Paul Stewart, San Diego, CA (US); Dick Ji-An Liu, San Diego, CA (US); Timothy Ryan Camise, Encinitas, CA (US); Neal Nai-Chang Yu, Pleasanton, CA (US)

(73) Assignee: GoPro, Inc., San Mateo, CA (US)

(21) Appl. No.: 18/162,954

(22) Filed: Feb. 1, 2023

(51) Int. Cl. G06F 9/4401

(52) U.S. Cl. CPC G06F 9/4418

(57) ABSTRACT

Systems, apparatus, and methods for “fast” wake-up using virtualized addresses. Action cameras need to conserve power most of the time, but also be immediately responsive to catch action when it happens. Unfortunately, most general-purpose operating systems (e.g., Linux-based) lock up the processor during boot-up. Empirically, an OS boot process might take between 6-7 seconds from start to finish, even in highly streamlined boot sequences. This is undesirable, especially where one device (e.g., a smart phone) triggers an action camera to capture an image. Various embodiments of the present disclosure create “virtual action addresses” that directly expose interrupts as addressable space (via a Bluetooth Low Energy (BLE) network). In one such example, the interrupts trigger a capture or other action. The action camera can immediately service the interrupts with its real-time operating system (RTOS) while the general-purpose OS is booting up.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of digital image capture and post-processing. More particularly, the present disclosure relates to systems, computer programs, devices, and methods for fast wake-up and capture of digital images in a real-time operating system (RTOS).

### DESCRIPTION OF RELATED TECHNOLOGY

Action cameras are a relatively recent phenomenon. Unlike studio photography which can be carefully composed and controlled, action cameras are typically designed to capture footage while on-the-move. For a variety of reasons, action cameras are typically compact, ruggedized, and designed to require minimal interaction once recording has begun. In most situations, the action camera user cannot control shooting conditions; interesting moments fleetingly occur and often cannot be replicated. As a result, speed and responsiveness are very important. In some cases, the user may have the camera off to save battery, but then, almost immediately need to power-on and capture action.

As an important tangent, most computing devices run an “operating system” (OS) to manage the device's ongoing tasks. Many OSes restrict access to the firmware/hardware resources of the device, within so-called “kernel space.” Typically, software applications are executed in an “application space.” To access the controlled resources, software applications must request, and then wait until they are granted access by the OS. A special class of operating systems can guarantee response times for tasks, these operating systems are referred to as real-time operating systems (RTOSs).

Real-time operating systems for cameras must continue to evolve to meet increasingly aggressive consumer demands.

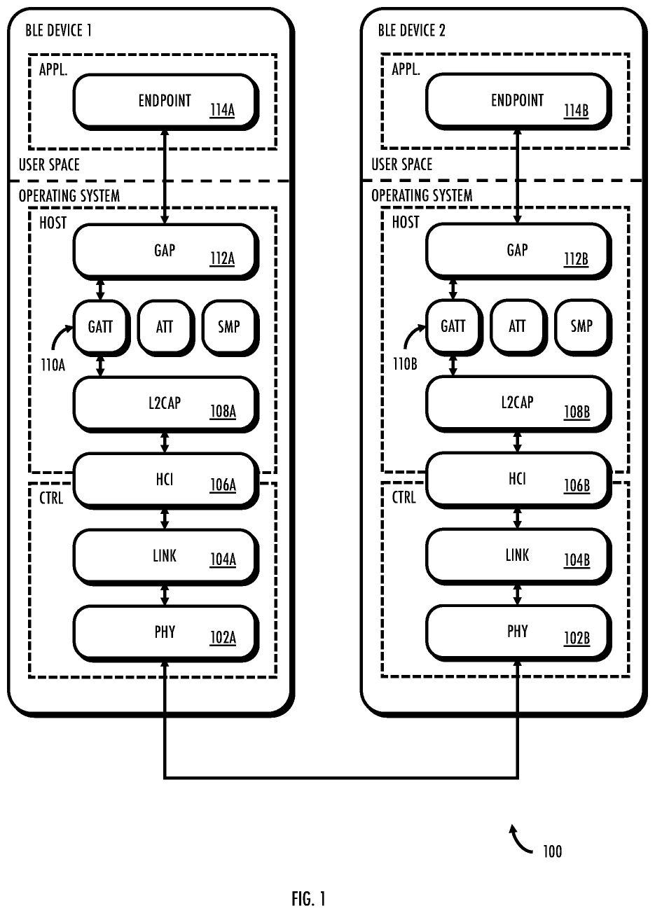

FIG. 1 is a logical block diagram of one exemplary Bluetooth Low Energy (BLE) communication stack.

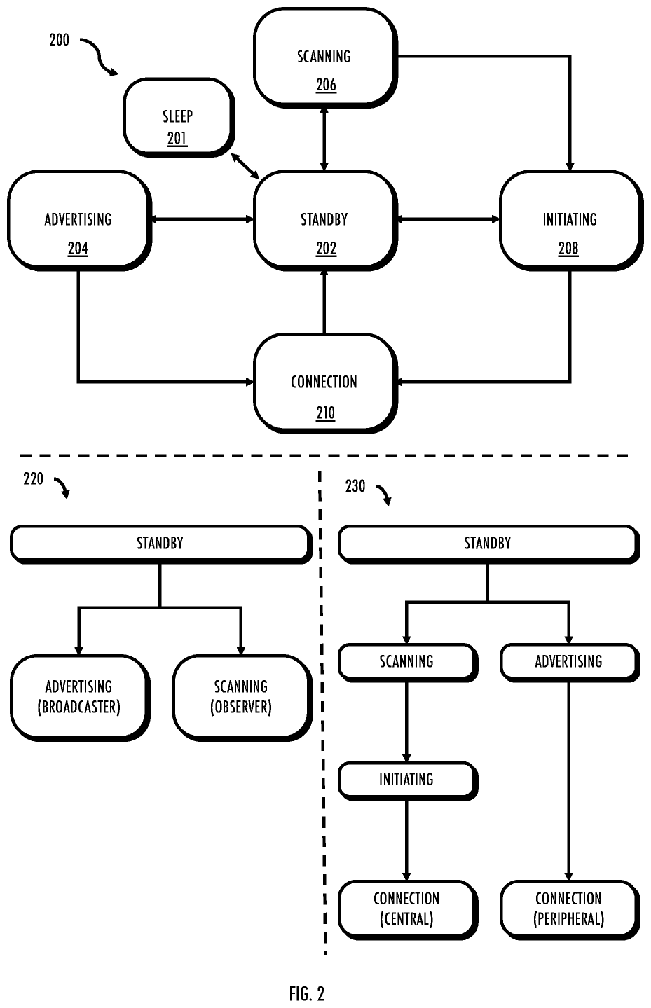

FIG. 2 is a logical block diagram of the BLE Link layer protocol, and exemplary state transitions for connectionless operation and connected operation.

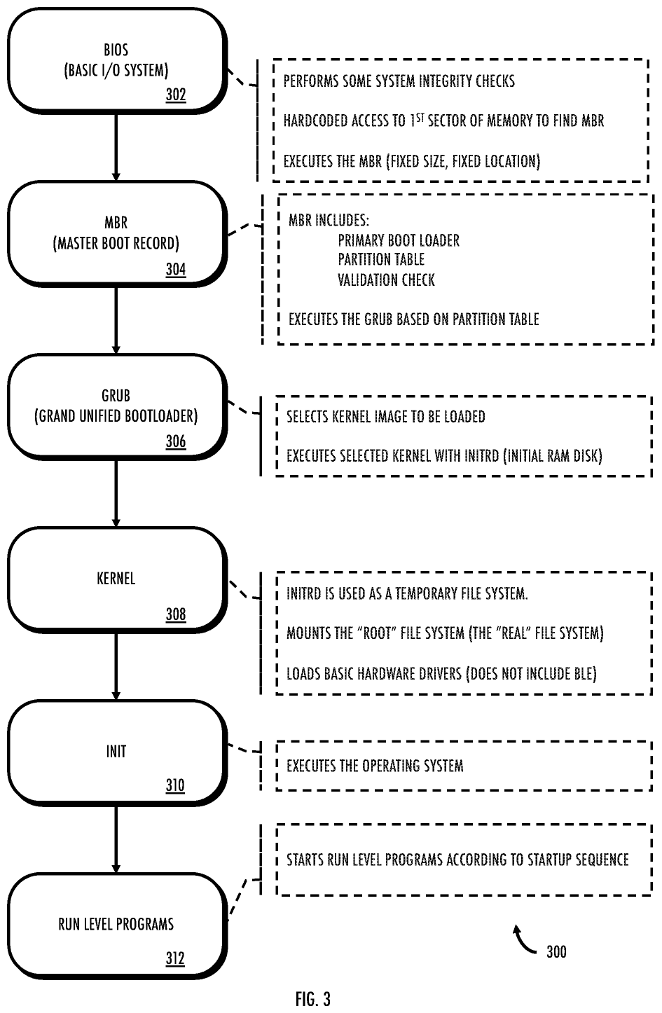

FIG. 3 is a logical block diagram of one generalized Linux boot process.

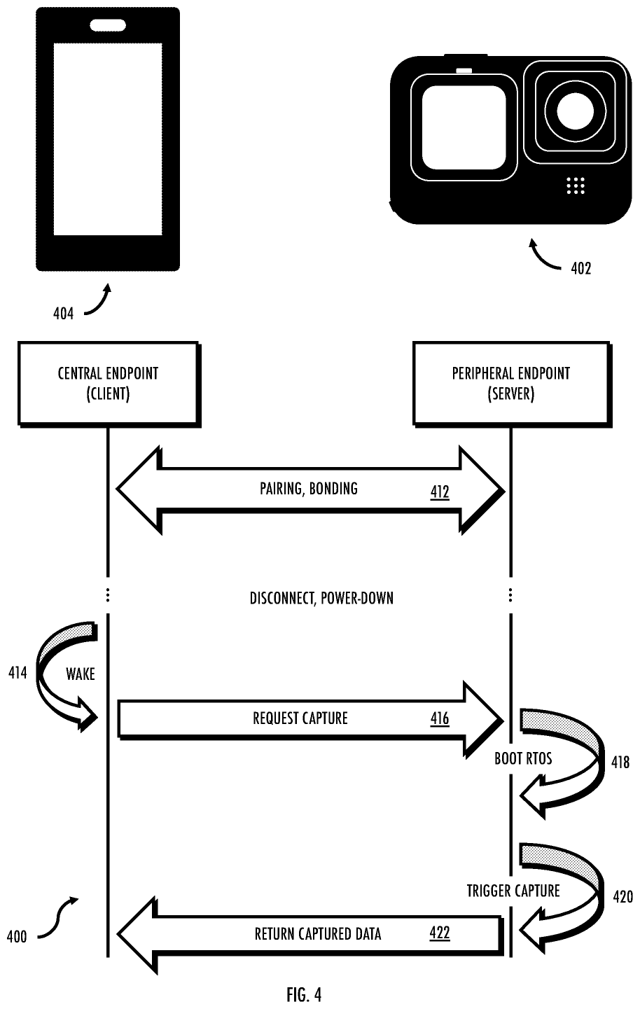

FIG. 4 is a logical flow diagram of a wake-up and capture scenario.

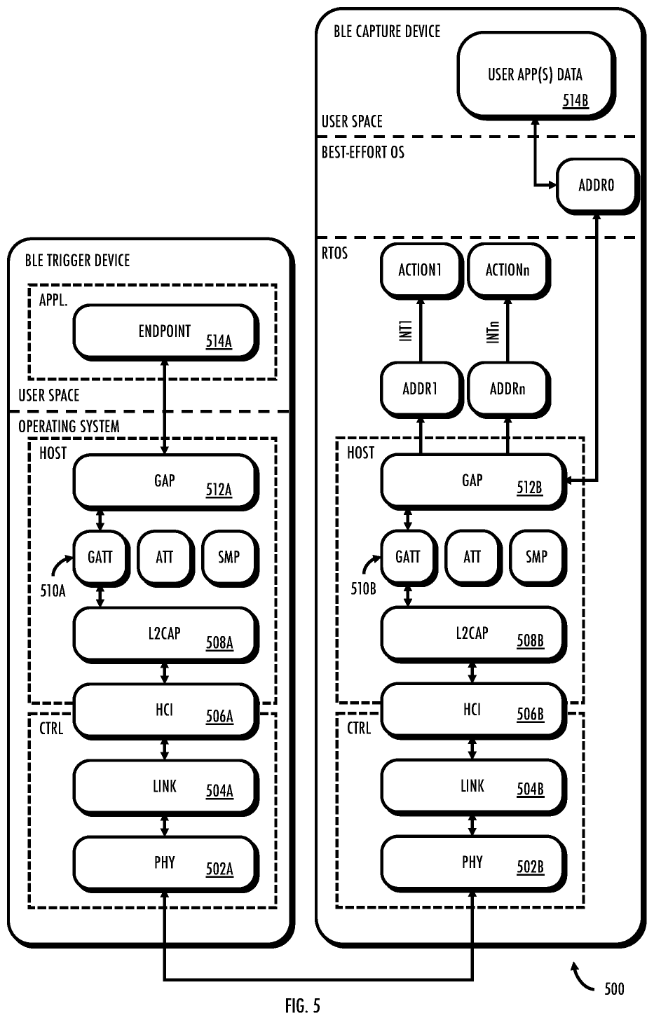

FIG. 5 is a logical block diagram of one exemplary “fast boot” Bluetooth Low Energy (BLE) communication stack, in accordance with various aspects of the present disclosure.

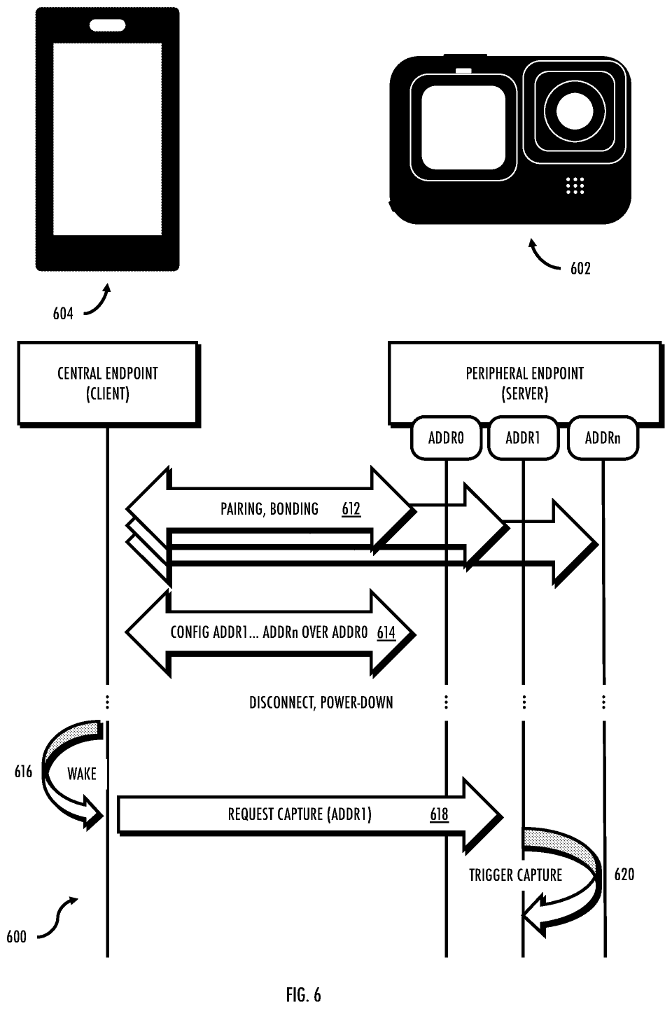

FIG. 6 is a logical flow diagram of a “fast” wake-up and capture scenario, in accordance with various aspects of the present disclosure.

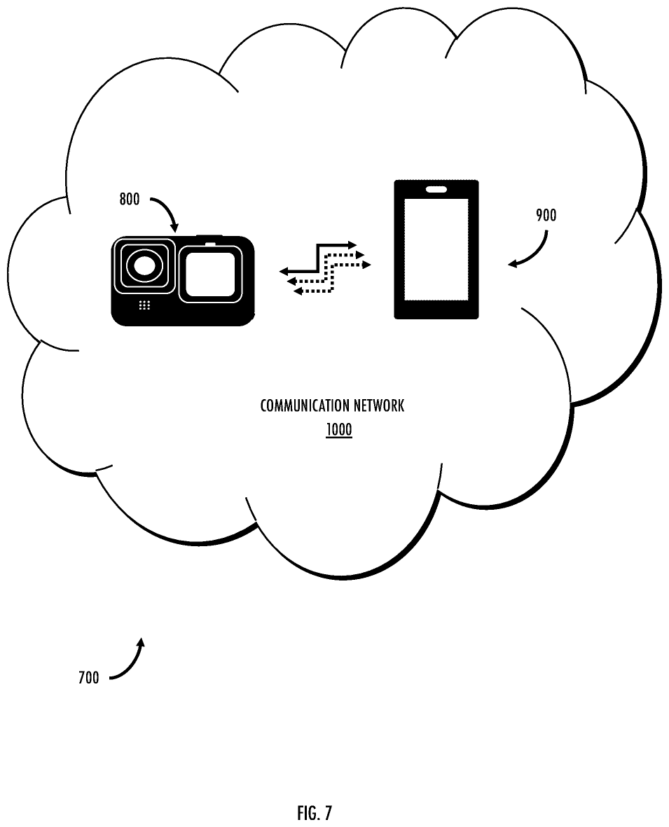

FIG. 7 is a logical block diagram of the exemplary system architecture, in accordance with various aspects of the present disclosure.

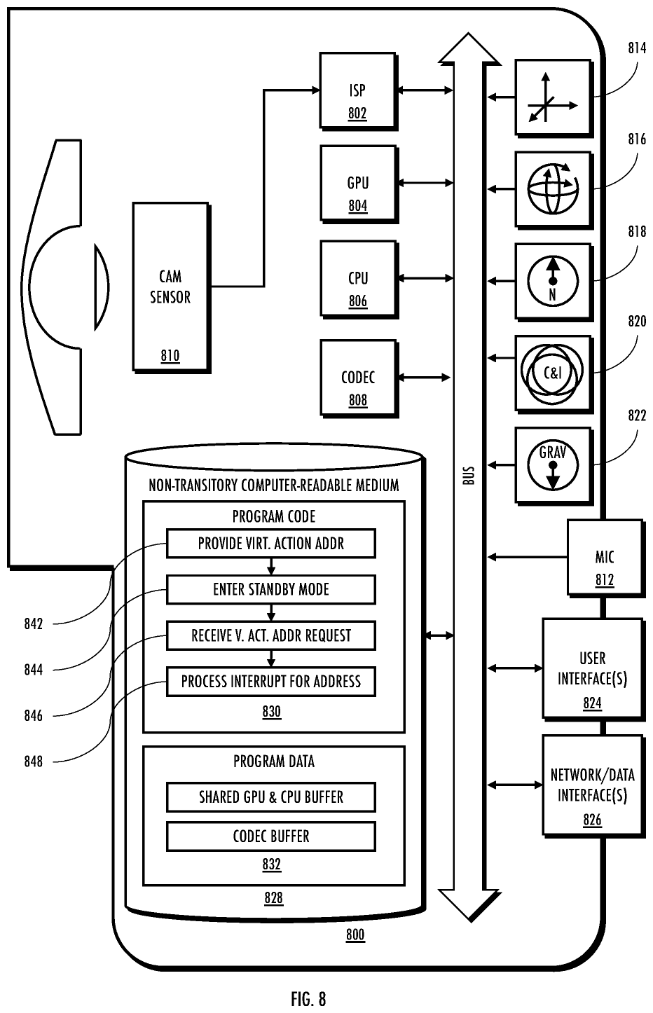

FIG. 8 is a logical block diagram of an exemplary action device, in accordance with various aspects of the present disclosure.

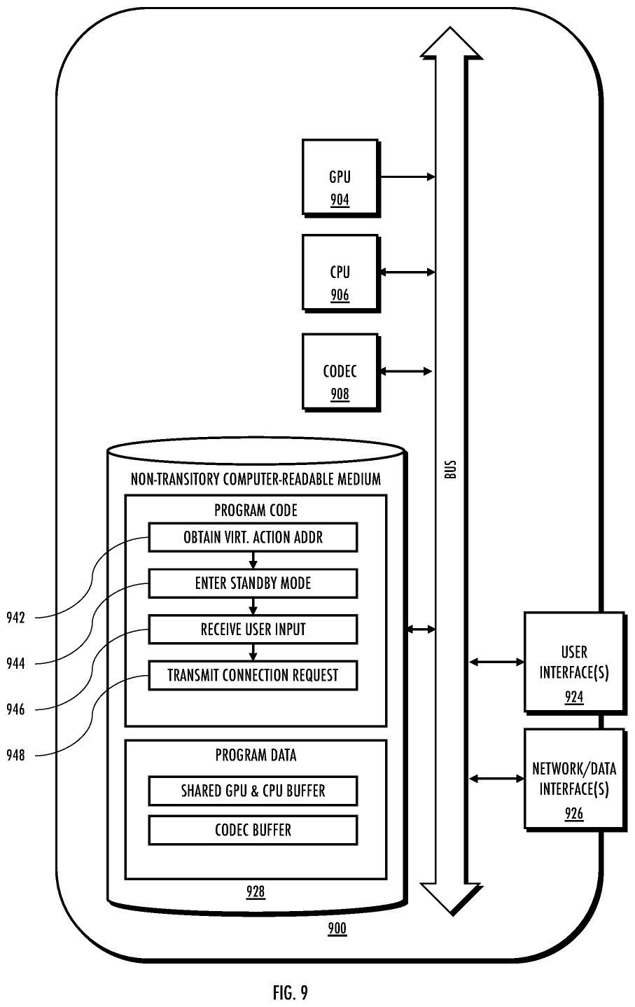

FIG. 9 is a logical block diagram of an exemplary control device 900, in accordance with various aspects of the present disclosure.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### Bluetooth Low Energy (BLE) Communication Stack

BLE is a wireless personal area network technology specifically focused on low energy applications. Bluetooth Low Energy is distinct from the Bluetooth Basic Rate/Enhanced Data Rate (BR/EDR) protocol, but the two protocols can both be supported by one device. The Specification of the Bluetooth System, Version 4.0, published Jun. 30, 2010, incorporated herein by reference in its entirety, and its subsequent versions, permit devices to implement either or both BLE and BR/EDR systems.

FIG. 1 is a logical block diagram of one exemplary Bluetooth Low Energy (BLE) communication stack 100. As shown, the BLE protocol is subdivided into a protocol stack composed of different layers of protocols. Each layer of the protocol stack communicates with its logical counterpart in another device; for example, the PHY layer 102A of a BLE device 1 communicates with the PHY layer 102B of BLE device 2, the LINK layer 104A of a BLE device 1 communicates with the LINK layer 104B of BLE device 2, etc. Each layer additionally provides a level of abstraction to the layer above it; for example, the PHY layer handles physical transmission functionality so that the link layer does not need to, etc. In one specific implementation, the BLE protocol stack is logically subdivided into: a Physical layer (PHY 102A, PHY 102B), a Link layer (LINK 104A, LINK 104B), a Host Controller Interface layer (HCI 106A, HCI 106B), a Logical Link Control Adaptation Protocol layer (L2CAP 108B, L2CAP 108B), Generic Attribute Profile (GATT 110A, GATT 110B), Generic Access Profile (GAP 112A, GAP 112B), and Endpoint 114A, Endpoint 114B.

The layers of the BLE communication stack can be conceptually subdivided into two (2) components, a controller subsystem and a host subsystem. The host-controller interface (HCI 106A, HCI 106B) provides a standardized communication interface between the host subsystem and the controller subsystems. Typically, the HCI interface allows a device manufacturer to source separate hardware and/or software for the host and controller subsystems. The HCI interface may be unnecessary for integrated systems (e.g., where both the host and controller subsystems are integrated within a single application specific integrated circuit (ASIC), etc.).

The host subsystem exposes different capabilities as “profiles” to the user applications (Endpoint 114A, Endpoint 114B). In the illustrated embodiment, the endpoints (114A, 114B) are connected to the BLE communication stack using a Generic Access Profile (GAP 112A, GAP 112B) with a Generic Attribute Profile (GATT 110A, GATT 110B), discussed in greater detail below. While the following discussion is presented in the context of a GAP/GATT connection, other profiles and/or roles may be substituted with equal success given the contents of the present disclosure.

The Generic Access Profile (GAP) defines two modes of communication: a connected mode and a connectionless (broadcast) mode. Referring first to connected communications, two endpoints establish a dedicated resource for communication; connected communications must explicitly connect and handshake to transfer data packets. Connected communications use a hub-and-spoke type topology; a central (hub) endpoint can communicate with many peripheral (spoke) endpoints. Peripheral endpoints advertise their presence to nearby central endpoints. A central endpoint can accept a connection request; once accepted, the central endpoint is solely responsible for initiating communication with the connected peripheral. The central endpoint is also solely responsible for managing the connection parameters; a peripheral endpoint can request modification, but only the central endpoint can modify connection parameters. Referring now to connection-less communications, communications are broadcast and do not require explicit connection i.e., a broadcaster broadcasts public advertising data packets, any observer can receive the broadcast packets. Broadcast communications also do not have a logical topology or centralized control.

The Generic Attribute Profile (GAP) defines a variety of roles that different endpoints can use. One set of particularly useful roles are the client role and server role. The GATT server's primary responsibility is to store data (and/or attributes). A GATT client can send a request to a GATT server; the request can read and write data and/or attributes of the GATT server.

GAP and GATT profiles are independent, but commonly used together. For example, a peripheral or central endpoint may act as either/both a server and client, depending on how data is transacted. For example, a button push on a central endpoint may be used to send a request to a peripheral endpoint to capture an image; in this case, the central endpoint is a client and the peripheral endpoint is a server. In an alternative implementation, a button push on a peripheral endpoint may be used to trigger a central endpoint to capture an image. In this scenario, the peripheral endpoint is a server that stores the button push status; the status is polled by the central endpoint.

Turning now to the control subsystem, the Link layer (LINK 104) transacts data packets according to specific addresses, pass keys, and time slots that are established according to the profiles (described above). FIG. 2 depicts a logical block diagram of the BLE Link layer protocol 200, and exemplary state transitions for connection-less operation 220 and connected operation 230.

When sleeping (sleep state 201), the BLE Link layer is unpowered. Periodically (or when triggered by another event), the BLE Link layer may wake-up and enter the standby state 202. Notably, the sleep state 201 may broadly encompass e.g., reset, power-off, and/or other low-power modes.

In the standby state 202, the BLE Link layer initializes itself and idles (neither transmitting or receiving data). The Link layer can enter the standby state from any of the other states. The standby state 202 may transition to other modes based on its wake event, profile, and/or roles.

In the advertising state 204, the BLE Link layer broadcasts advertisement packets that can be received by any nearby BLE endpoint. The advertisement packet broadcasts the endpoint's presence and may include connection information. The advertising state 204 can only be entered from the standby state 202.

In the scanning state 206, the BLE Link layer listens for packets that are broadcasted by other nearby endpoints.

In the initiating state 208, the BLE Link layer attempts to establish a connection to another endpoint based on its selected role. For example, a peripheral endpoint may request a connection during the initiating state 208. Similarly, the central endpoint may grant a connection during the initiating state 208. The initiating state 208 can only be entered from the standby state 202.

During the initiating state 208, the endpoints may exchange the information necessary to establish an encrypted connection. This “pairing” exchange involves authenticating the identity of the two endpoints to be paired, encrypting the link, and distributing cryptographic keys (“pass keys”) to allow security to be restarted on a re-connection. Once paired, the endpoints may additionally “bond” such that the information from the pairing process is stored for future use; in other words, once paired and bonded, endpoints may freely and securely re-connect using automatic re-connection procedures.

In slightly more detail, the pairing process uses a custom key exchange protocol. The endpoints first exchange a temporary key (TK), to create a short-term key (STK) which is used to encrypt the connection. For example, a first endpoint sends a pairing request to the other endpoint. The two endpoints then exchange I/O capabilities, authentication requirements, maximum link key size, bonding requirements, and/or any other preliminary connection requirements. The endpoints then each internally generate and/or exchange a TK based on the accepted pairing methods. Once both endpoints have a shared TK, they may exchange random values to exchange a STK. The STK is used to encrypt the ongoing connection. For endpoints that form a long-term bond, several additional transport specific keys and/or random numbers may be exchanged to create a long-term key (LTK)—the LTK enables a re-connection after disconnecting.

In some BLE implementations, the endpoints may use a “white list” in their link layer processing to quickly re-connect/ignore connection requests. The white list stores the addresses for all permitted endpoints and is used for endpoint filtering. White lists can greatly improve standby power consumption by ignoring unknown advertising packets, scan requests, or connection requests. In other words, only previously permitted connections are sent to the higher layers for handling. Permitted addresses can use the aforementioned automatic re-connection procedure; i.e., the controller subsystem can immediately re-establish a connection (re-connect) to any endpoint address that matches an address stored in the white list.

Referring back to FIG. 2, once the BLE Link layer has an established connection, it can transact data packets with its connected endpoints (connection state 210).

As a helpful illustration, FIG. 2 further elaborates the link layer protocol 200 and GAP/GATT connection sequences with respect to connection-less operation 220 and connected operation 230. During connection-less operation 220, the broadcaster advertises information and the observer scans for information; no ongoing connection state is necessary. During connected operation 230, a peripheral advertises its presence; the central endpoint scans for peripherals and may selectively initiate connections.

Referring back to FIG. 1, the physical layer (PHY 102) is responsible for transmission/reception and encoding/decoding the radio waves into digital signals (e.g., carried via the Industrial Scientific Medical (ISM) 2.4 GHz band). BLE uses GFSK (Gaussian Frequency Shift-Keying) modulation and a time-division multiplexing scheme to transmit data packets over a set of time slots. The parameters for the PHY layer are configured by the profiles (described above). For example, a GAP/GATT profile central endpoint could configure a repeating 7.5 ms connection interval that contains twelve (12) timeslots of 625 μs (timeslots 0-11). The central endpoint might only start communication on even numbered time slots (0, 2, 4, etc.), and the peripheral endpoints might only reply on odd numbered time slots. In some variants, the connection interval might support multi-slot packets (e.g., 1 time slot, 3 time slots, 5 time slots, etc.).

As previously alluded to, BLE connections are designed for low-power devices. Unlike Bluetooth Basic Rate/Enhanced Data Rate (BR/EDR) which maintain links until they are broken, most BLE endpoints are expected to power-off to save energy. In fact, most BLE endpoints remain in sleep mode unless a connection is initiated. Usually, actual connection times usually last only a few milliseconds at a time (compared to Bluetooth BR/EDR which may maintain connections for hours).

### Operating Systems, Functions, and Boot Sequencing

An operating system (OS) refers to the suite of system software that manages computer hardware, firmware, and software resources. An OS supports processing functions such as e.g., task scheduling, application execution, input and output management, memory management, security, and peripheral access. During normal operation, the OS acts as a secure “gate keeper” between user applications and the computer hardware. Each user application may request resources (e.g., memory and/or input/output) from the OS; the OS may allocate and reserve the user application's resources to prevent resource conflicts with other applications.

As a brief aside, user space is a portion of system memory that a processor executes user processes from. User space is relatively freely and dynamically allocated for application software and a few device drivers. The kernel space is a portion of memory that a processor executes the kernel from. Kernel space is strictly reserved (usually during the processor boot sequence) for running privileged operating system (OS) processes, extensions, and most device drivers. For example, each user space process normally runs in a specific memory space (its own “sandbox”) and cannot access the memory of other processes unless explicitly allowed. In contrast, the kernel is the core of a device's operating system; the kernel can exert complete control over all other processes in the system.

As used herein, the term “privilege” may refer to any access restriction or permission which restricts or permits processor execution. System privileges are commonly used within the computing arts to, inter alia, mitigate the potential damage of a computer security vulnerability. For instance, a properly privileged computer system will prevent malicious software applications from affecting data and task execution associated with other applications and the kernel.

Most software applications are implemented within one or more threads. A “thread” is the smallest discrete unit of processor utilization that may be scheduled for a core to execute. A thread is characterized by: (i) a set of instructions that is executed by a processor, (ii) a program counter that identifies the current point of execution for the thread, (iii) a stack data structure that temporarily stores thread data, and (iv) registers for storing arguments of opcode execution.

Commonly accepted software design principles use layers of abstraction to prevent unintended/malicious behaviors. For example, a processor may execute a first thread with a dedicated resource, and then “context switch” to second thread. The second thread cannot access the first resource directly; instead, the second thread may only affect the first resource (e.g., via a callback to the first thread). Once the second thread has completed its tasks, the processor will eventually switch back to the first thread to complete the operation. In most operating systems, the task scheduling between threads is “best-effort” i.e., no specific time guarantee is provided. In other words, the first thread cannot rely on a thread resuming within any guaranteed time frame.

As used herein, a “context switch” is the process of storing the state of a process, or of a thread, so that it can be restored, and execution resumed from the same point later. This allows multiple threads to share a single processor. Excessive amounts of context switching can slow processor performance down. While the present discussion is primarily discussed within the context of a single processor, multi-processor systems have analogous concepts (e.g., multiple processors also perform context switching, although contexts may not necessarily be resumed by the same processor).

Linux and its many variants (“distributions”) are an example of one widely distributed and commonly used general-purpose OS (best-effort scheduling). Linux is widely disseminated with favorable licensing terms and has become a common “base” OS that is modified for many different applications. In many cases, Linux distributions are used for embedded and real-time operating systems.

FIG. 3 is a logical block diagram of one generalized Linux boot process 300. As shown, the Linux kernel boots in six (6) generalized steps.

At step 302, the processor boots at its default start address (typically, 0x0000000) to initialize its basic input/output system (BIOS) and perform some system integrity checks. If the check sequence is successful, then the processor searches for the address of the master boot record (MBR), which is typically hardcoded to be within the 1^{st} sector of memory (at a fixed size and location). If successful, then the BIOS transfers control to the MBR.

The MBR is usually no more than 512 B (bytes) in size; this is traditionally split into 3 components: a primary boot loader (446 B), a partition table (64 B) and a validation check (2 B). When executed (step 304), the MBR discovers and executes the grand unified bootloader (GRUB) based on the partition table.

The grand unified bootloader (GRUB) includes the addresses of all kernels (for systems that have multiple kernels). At step 306, the GRUB loads the default kernel (or an alternate kernel, if selected). The GRUB also has access to the full filesystem in memory and configures the memory initialization sequence (initrd, see step 310 below).

The kernel process temporarily mounts the root filesystem and executes the memory initialization sequence (step 308). Initial ram disck (initrd) is used as a temporary root file system until the kernel has completely booted the real filesystem (step 310); initrd may also contain some device drivers to access memory partitions and/or other hardware.

Once initrd (process identifier 0) has completed, the kernel can start run level programs (step 312), according to their start-up initialization parameters. Run level programs are executed according to an explicit name and sequence number i.e., “S” indicates that the program is included during start-up, and a two-digit number designates its sequential order. For example, S02 [program_name], S03 [program_name], S04 [program_name], etc. are the second, third, and fourth process threads that are executed, respectively.

Notably, a Linux kernel does not begin to execute run level applications until after the boot sequence has completed. Empirically, the foregoing Linux boot process takes between 6-7 seconds from start to finish, even in highly streamlined boot sequences.

Certain applications have special considerations that are unusual for general-purpose (best-effort scheduling) operating systems. In many cases, these applications constrain OS thread scheduling and resource management. So-called “real-time operating systems” (RTOSes) are specifically designed for use in “real-time” applications that must process events according to specified time constraints. Examples of real-time constraints may include e.g.: thread execution before an event, thread execution within a time window after an event, total thread execution duration, etc. While the following discussions are presented in the context of RTOSes, the techniques may be broadly used in other operating system environments. For example, so-called embedded operating systems are designed for embedded applications which may be constrained to embedded hardware limitations (e.g., bandwidth, memory space, power consumption, etc.) In other examples, so-called distributed and/or multi-user operating systems that are designed for multiple devices and/or users.

### Exemplary “Fast Boot” BLE Communication Stack

Consider the scenario 400 depicted in FIG. 4; as shown, an action camera 402 is positioned to capture a particular shot. The action camera 402 is paired to a smart phone 404; in this example, the smart phone 404 is a central endpoint and the action camera 402 is a peripheral endpoint. Mobile devices often need to conserve battery for a full-day's use; so shortly after pairing and bonding (step 412), both devices idle and/or power-down. The BLE modems in each device remain in standby mode-they consume very little power but may periodically transition into scanning states for nearby BLE events.

A little later, the user wakes their smart phone 404 and prepares to remotely trigger a capture (step 414). Unfortunately, the action camera 402 is unaware of smart phone activity and remains asleep.

Once the desired event occurs, the user attempts to trigger a capture (step 416). The BLE central endpoint of the smart phone 404 sends a request as a client. The BLE peripheral endpoint receives the request and attempts to wake the action camera 402 to service the capture. Since the action camera 402 must “cold-start” its OS (Linux-based), the boot sequence takes between 6-7 seconds to complete (step 418).

After booting, the action camera 402 captures an image (step 420) and returns its connection status via the BLE communication stack (step 422); the captured data may be stored in memory (either operational or removeable memory media). Nearly 8 seconds has elapsed from the point of trigger to the actual capture-most of this time was booting the OS.

Unlike traditional photography, action photography is highly dynamic; interesting moments fleetingly occur and often cannot be replicated. In other words, speed and responsiveness are very important for an action camera, so any significant wake-up delay may be undesirable. Ideally, new solutions for quickly triggering action are needed.

Various aspects of the present disclosure provide access to a “fast boot” or a “fast wake-up” real-time operating system (RTOS) to improve reaction time. In one embodiment, an action camera (a BLE peripheral endpoint) creates a number (o, 1, . . . , n) of “virtual action addresses” that may be distributed to a smart phone (a BLE central endpoint) in the mobile ecosystem. The virtual action addresses may be used to perform pre-defined tasks within the action camera's real-time operating system (RTOS), outside of the general-purpose operating system (e.g., Linux-based OS). In one such implementation, the different operating systems may be operating from different processor cores of a multi-core processor system (e.g., Linux OS may run from a first set of cores, a RTOS may be running on a second set of cores). In this manner, the action camera might be instructed to start recording, before the general-purpose OS has completed its boot sequence.

In one exemplary embodiment, the “virtual action addresses” directly expose interrupts that are serviced by the RTOS as addressable space (via the BLE network). The RTOS services the interrupts by performing their corresponding pre-defined tasks (e.g., capture an image, video, etc.). As used herein, the term “interrupt” refers to a processor request that preempts currently executing threads (when permitted), for event processing. In other words, the processor suspends its current task execution, to handle the interrupt. After servicing the interrupt, the processor resumes its suspended task. For instance, the interrupt may trigger real-time scheduling of the pre-defined task according to its specified time constraints. Unlike best-effort style scheduling which does not guarantee execution time, interrupt-based scheduling in a RTOS can be used to greatly improve response time, robustness, and consistency (e.g., within 50 ms, if necessary). In other words, the RTOS will schedule the specified task for execution just like any other real-time task.

In one specific variants, the creation and configuration of the virtual action addresses and their pre-defined actions may be performed over an active connection—i.e., after the initial BLE pairing/bonding, but before the intended usage. The configuration process may be exposed to the user via a drag-and-drop-style macro programming GUI on their smart phone (or another capable device). For example, the GUI may display a set of virtual action addresses that the user can select and assign different actions and corresponding scheduling constraints (if any). In some cases, the programming GUI may be incorporated into a suite of other useful action camera software (e.g., as part of an on-the-go video editor, etc.).

FIG. 5 is a logical block diagram of one exemplary “fast boot” or “fast wake-up” Bluetooth Low Energy (BLE) communication stack 500. As shown, the “fast boot” or “fast wake-up” BLE communication stack retains many of conventional BLE protocol layers, e.g., a Physical layer (PHY 502A, PHY 502B), a Link layer (LINK 504A, LINK 504B), a Host Controller Interface layer (HCI 506A, HCI 506B), a Logical Link Control Adaptation Protocol layer (L2CAP 508A, L2CAP 508B), Generic Attribute Profile (GATT 510A, GATT 510B), Generic Access Profile (GAP 512A, GAP 512B), and Endpoint 514A, Endpoint 514B. Conventional BLE protocol operation is discussed above (see e.g., Bluetooth Low Energy (BLE) Communication Stack).

In one exemplary embodiment, the action camera selects the GAP/GATT peripheral profiles and server roles. In other words, the action camera can serve data requests from a central endpoint client (e.g., nearby smart phone). However, instead of just a single endpoint, the action camera additionally creates a number of virtual addresses (1, . . . , n) for itself, each of which is separately addressable by the central endpoint. These addresses are “virtual action addresses” in that they do not refer to a physical device, but instead trigger an action/task execution.

As a brief aside, conventional Bluetooth devices use a unique 48-bit address (also referred to as a MAC address, or BD_ADDR) that uniquely identifies the device. There are several different types of addresses: public addresses, random static addresses, random private resolvable addresses, and random private non-resolvable addresses. A public address is guaranteed to be unique globally, can never be changed, and is registered with external 3^{rd} party entities (e.g., the IEEE Registration Authority). In contrast, random addresses do not require registration and can be generated according to certain constraints. Random static addresses can be changed at boot-up, but cannot be changed during run-time. Random private resolvable addresses can be randomly generated and exchanged during pairing/bonding; subsequent re-connection can re-use the random private resolvable addresses between devices. Finally, non-resolvable random private addresses cannot be resolved and are only used by beacon applications.

Within the context of the present disclosure, a single device may create and service multiple endpoint addresses using the random static address format generated at manufacture. The random static address format uses 1, 1 in the most significant bits (MSB) and 46 bits chosen by the manufacturer. To further streamline re-connection, the newly created addresses may be added to the action camera's BLE link layer white list. In other words, the link layer will filter messages (obviating higher layer processing) to only accept the endpoint's own address and its virtual action addresses. Other implementations may substitute e.g., public addresses, random private resolvable addresses, random private non-resolvable addresses, etc. with equal success.

Referring back to FIG. 5, the action camera reserves an address for its endpoint (ADDR0), and associates each of the virtual action addresses (ADDR1, . . . , ADDRn) to an interrupt that triggers RTOS processing. In some cases, the interrupts may be true hardware interrupts. In other implementations, the interrupts may be emulated within software (e.g., a single HW interrupt line that corresponds to an array of SW interrupts (a message signaled interrupt), etc.). The action camera may support active connections via its endpoint address (which may include configuring the virtual action address behaviors). In some cases, the virtual action addresses may be hardcoded to perform a specific task. In other cases, the virtual action addresses may be configurable. Configurable implementations may use processing threads that can be easily described within macros (e.g., start a process, stop a process, etc.).

Referring now to FIG. 6, consider the following scenario 600. As shown, the action camera 602 and smart phone 604 start their BLE communication stacks. The action camera 602 advertises the presence of its endpoint address (ADDR0), and its virtual action addresses (ADDR1, . . . , ADDRn). Each address is associated with its own time slot of the connection interval (e.g., ADDR0 could be in time slot 1, ADDR1 could be in timeslot 3, ADDRn could be in timeslot 5, etc.). The smart phone 604 pairs and bonds to any/all of the addresses (step 612). In some variants, each of the addresses may have different encryption keys; in other variants, the addresses share the same encryption key.

At step 614, the user configures the virtual action addresses (ADDR1, . . . , ADDRn) using the existing endpoint address (ADDR0). The configuration process may be based in a drag-and-drop-style macro programming GUI. In this case, the user may define three separate virtual action addresses: an image capture address, a video start address, and a video stop address. The virtual action address for image capture might start individual threads for e.g., autofocus, select a shutter angle and ISO, adjust exposure, and take a shot, etc. The video start virtual action address might start individual threads for a video capture (e.g., autofocus, select a shutter angle and ISO, adjust exposure, start video, etc.), and the video stop virtual action address might start individual threads that stop an ongoing video capture and encode the resulting video. Once programmed, both devices may disconnect and/or power-down if necessary.

A little later, the user wakes their smart phone 604 and prepares to remotely trigger a capture (step 616). The action camera 602 remains unaware of smart phone activity and remains asleep.

Once the desired event occurs, the user attempts to trigger a capture (step 618). The BLE central endpoint of the smart phone 604 sends a request as a client. The BLE peripheral endpoint receives the request (passed through its whitelist) and immediately sees a connection request for a virtual action address; here, the capture is requested on ADDR1. In response, the ISP of the action camera 602 schedules real-time threads to e.g., autofocus, select a shutter angle and ISO, adjust exposure, and take a shot, etc. (step 620). This may occur in parallel with the action camera 602 general-purpose OS (e.g., Linux-based) boot sequence. Notably, the RTOS manages the camera-specific real-time operations and provides real-time guarantees for e.g., resuming execution from a suspended state (e.g., within 50 ms) and thread execution, whereas the Linux OS manages its tasks at best-effort and boots on a much slower time frame (e.g., 6-7 s). More broadly, these techniques may be broadly applicable to any fast wake-up and/or lightweight RTOS that can start running immediately, independently of a general-purpose OS boot.

In this case, the user experiences a “fast boot” or a “fast wake-up” that allows for immediate image capture. Then, once the general-purpose OS (e.g., Linux-based) boot sequence has successfully completed, the captured image can be returned via the endpoint address (ADDR0), under the existing software applications (running via the Linux OS) that the user is familiar with.

### Exemplary Mobile Ecosystem Architecture

### System Architecture

FIG. 7 is a logical block diagram of the exemplary system 700 that includes: an action device 800, a control device 900, and a communication network 1000. During a set-up sequence, the action device 800 and control device 900 determine one or more actions that can be “virtually addressed” via the communication network 1000. Once set-up, the control device 900 can trigger a “fast wake-up” of the action device 800 to perform actions, by accessing the “virtual addresses” on the communication network 1000. While the examples are presented in the context of a two-party transaction, the techniques may be readily extended to any number of network participants. For example, a third device (not shown) could trigger the actions of the action device 800.

While the foregoing discussion was presented in the context of a fast wake-up or fast-boot Bluetooth Low Energy (BLE) communication stack for an action camera, the system may have broad applicability to any communication requiring rapid response from devices that are otherwise pre-occupied. In other words, any rapid action or response that can be solicited or elicited without diverting processing and/or logic resources from ongoing tasks may be “virtually addressed” and scheduled in parallel.

The following discussion provides functional descriptions for each of the logical entities of the exemplary system 700. Artisans of ordinary skill in the related arts will readily appreciate that other logical entities that do the same work in substantially the same way to accomplish the same result are equivalent and may be freely interchanged. A specific discussion of the structural implementations, internal operations, design considerations, and/or alternatives, for each of the logical entities of the exemplary system 700 is separately provided below.

### Functional Overview of the Action Device

Functionally, an action device 800 preemptively executes an action in response to an instruction that was received at a virtual action address of a communication network. In different implementations, the action may be executed in parallel with a boot sequence (on other processing logic), preempt the boot sequence, or even change the boot sequence. More generally however, the techniques could broadly apply to any device that would benefit from more responsive re-connection of paired/bonded relationships.

As used herein, the term “preemption” and its linguistic derivatives refers to prioritized thread execution that temporarily interrupts another thread execution (the interrupted thread may or may not be later resumed). Priority may be based on execution order, execution time, and/or execution resources.

As used herein, the term “instruction” refers to any data structure that, when interpreted by a processor, causes the processor to perform an “action.” An action may be logically executed as one or more threads (the smallest discrete unit of processor utilization that may be scheduled for a core to execute) that operate on, capture, generate, or otherwise manipulate data.

As used herein, the term “virtual action address” refers to an address that is monitored to trigger action/task execution (i.e., the address is not a unique entity of a network node). Typically, an action device would be associated with a single network address, however the exemplary action devices may have multiple virtual action addresses. In some variants, the action device may additionally have secondary processing resources that may be able to perform tasks without the benefit of the primary processing resource.

In one specific example, an action camera may have a network endpoint address for network communications, but also respond to one or more virtual action addresses for various camera functions (e.g., image capture, video capture, etc.) In one specific implementation, the action camera may include a primary central processing unit for executing the operating system (OS), and supplemental processing for e.g., image capture, encoding, transmission/reception.

The techniques described throughout may be broadly applicable to co-processor devices such as cellular phones, laptops, smart watches, and/or IoT devices. For example, a smart phone may be able to receive network data via its modem before completing its boot procedure, etc. Similarly, a media center may be able to e.g., encode/decode and/or play media while also booting its onboard OS. Various other applications may be substitute with equal success by artisans of ordinary skill in the related arts, given the contents of the present disclosure.

FIG. 8 is a logical block diagram of an exemplary action device 800. The action device 800 includes: a sensor subsystem, a user interface subsystem, a communication subsystem, a control and data subsystem, and a bus to enable data transfer. The following discussion provides a specific discussion of the internal operations, design considerations, and/or alternatives, for each subsystem of the exemplary action device 800.

### Functional Overview of the Sensor Subsystem

Functionally, the sensor subsystem senses the physical environment and captures and/or records the sensed environment as data. In some embodiments, the sensor data may be stored as a function of capture time (so-called “tracks”). Tracks may be synchronous (aligned) or asynchronous (non-aligned) to one another. In some embodiments, the sensor data may be compressed, encoded, and/or encrypted as a data structure (e.g., MPEG, WAV, etc.)

The illustrated sensor subsystem includes: a camera sensor 810, a microphone 812, an accelerometer (ACCL 814), a gyroscope (GYRO 816), and a magnetometer (MAGN 818).

Other sensor subsystem implementations may multiply, combine, further subdivide, augment, and/or subsume the foregoing functionalities within these or other subsystems. For example, two or more cameras may be used to capture panoramic (e.g., wide or 360°) or stereoscopic content. Similarly, two or more microphones may be used to record stereo sound.

In some embodiments, the sensor subsystem is an integral part of the action device 800. In other embodiments, the sensor subsystem may be augmented by external devices and/or removably attached components (e.g., hot-shoe/cold-shoe attachments, etc.) The following sections provide detailed descriptions of the individual components of the sensor subsystem.

### Camera Implementations and Design Considerations

In one exemplary embodiment, a camera lens bends (distorts) light to focus on the camera sensor 810. In one specific implementation, the optical nature of the camera lens is mathematically described with a lens polynomial. More generally however, any characterization of the camera lens' optical properties may be substituted with equal success; such characterizations may include without limitation: polynomial, trigonometric, logarithmic, look-up-table, and/or piecewise or hybridized functions thereof. In one variant, the camera lens provides a wide field-of-view greater than 90°; examples of such lenses may include e.g., panoramic lenses 120° and/or hyper-hemispherical lenses 180°.

In one specific implementation, the camera sensor 810 senses light (luminance) via photoelectric sensors (e.g., CMOS sensors). A color filter array (CFA) value provides a color (chrominance) that is associated with each sensor. The combination of each luminance and chrominance value provides a mosaic of discrete red, green, blue value/positions, that may be “demosaiced” to recover a numeric tuple (RGB, CMYK, YUV, YCrCb, etc.) for each pixel of an image.

In some embodiments, the camera resolution directly corresponds to light information. In other words, the Bayer sensor may match one pixel to a color and light intensity (each pixel corresponds to a photosite). However, in some embodiments, the camera resolution does not directly correspond to light information. Some high-resolution cameras use an N-Bayer sensor that groups four, or even nine, pixels per photosite. During image signal processing, color information is re-distributed across the pixels with a technique called “pixel binning”. Pixel-binning provides better results and versatility than just interpolation/upscaling. For example, a camera can capture high resolution images (e.g., 108 MPixels) in full-light; but in low-light conditions, the camera can emulate a much larger photosite with the same sensor (e.g., grouping pixels in sets of 9 to get a 12 MPixel “nona-binned” resolution). Unfortunately, cramming photosites together can result in “leaks” of light between adjacent pixels (i.e., sensor noise). In other words, smaller sensors and small photosites increase noise and decrease dynamic range.

More generally however, the various techniques described herein may be broadly applied to any camera assembly; including e.g., narrow field-of-view (30° to 90°) and/or stitched variants (e.g., 360° panoramas). While the foregoing techniques are described in the context of perceptible light, the techniques may be applied to other EM radiation capture and focus apparatus including without limitation: infrared, ultraviolet, and/or X-ray, etc.

### Microphone Implementations and Design Considerations

In one specific implementation, the microphone 812 senses acoustic vibrations and converts the vibrations to an electrical signal (via a transducer, condenser, etc.) The electrical signal may be further transformed to frequency domain information. The electrical signal is provided to the audio codec, which samples the electrical signal and converts the time domain waveform to its frequency domain representation. Typically, additional filtering and noise reduction may be performed to compensate for microphone characteristics. The resulting audio waveform may be compressed for delivery via any number of audio data formats.

Commodity audio codecs generally fall into speech codecs and full spectrum codecs. Full spectrum codecs use the modified discrete cosine transform (mDCT) and/or mel-frequency cepstral coefficients (MFCC) to represent the full audible spectrum. Speech codecs reduce coding complexity by leveraging the characteristics of the human auditory/speech system to mimic voice communications. Speech codecs often make significant trade-offs to preserve intelligibility, pleasantness, and/or data transmission considerations (robustness, latency, bandwidth, etc.)

More generally however, the various techniques described herein may be broadly applied to any integrated or handheld microphone or set of microphones including e.g., boom and/or shotgun-style microphones. While the foregoing techniques are described in the context of a single microphone, multiple microphones may be used to collect stereo sound and/or enable audio processing. For example, any number of individual microphones can be used to constructively and/or destructively combine acoustic waves (also referred to as beamforming).

### Inertial Measurement Unit (IMU) Implementations and Design Considerations

The inertial measurement unit (IMU) includes one or more accelerometers, gyroscopes, and/or magnetometers. In one specific implementation, the accelerometer (ACCL 814) measures acceleration and gyroscope (GYRO 816) measure rotation in one or more dimensions. These measurements may be mathematically converted into a four-dimensional (4D) quaternion to describe the device motion, and electronic image stabilization (EIS) may be used to offset image orientation to counteract device motion (e.g., CORI/IORI 820). In one specific implementation, the magnetometer (MAGN 818) may provide a magnetic north vector (which may be used to “north lock” video and/or augment location services such as GPS), similarly the accelerometer (ACCL 814) may also be used to calculate a gravity vector (GRAV 822).

Typically, an accelerometer uses a damped mass and spring assembly to measure proper acceleration (i.e., acceleration in its own instantaneous rest frame). In many cases, accelerometers may have a variable frequency response. Most gyroscopes use a rotating mass to measure angular velocity; a MEMS (microelectromechanical) gyroscope may use a pendulum mass to achieve a similar effect by measuring the pendulum's perturbations. Most magnetometers use a ferromagnetic element to measure the vector and strength of a magnetic field; other magnetometers may rely on induced currents and/or pickup coils. The IMU uses the acceleration, angular velocity, and/or magnetic information to calculate quaternions that define the relative motion of an object in four-dimensional (4D) space. Quaternions can be efficiently computed to determine velocity (both device direction and speed).

More generally, however, any scheme for detecting device velocity (direction and speed) may be substituted with equal success for any of the foregoing tasks. While the foregoing techniques are described in the context of an inertial measurement unit (IMU) that provides quaternion vectors, artisans of ordinary skill in the related arts will readily appreciate that raw data (acceleration, rotation, magnetic field) and any of their derivatives may be substituted with equal success.

### Functional Overview of the User Interface Subsystem

Functionally, the user interface subsystem 824 may be used to present media to, and/or receive input from, a human user. Media may include any form of audible, visual, and/or haptic content for consumption by a human. Examples include images, videos, sounds, and/or vibration. Input may include any data entered by a user either directly (via user entry) or indirectly (e.g., by reference to a profile or other source).

The illustrated user interface subsystem 824 may include: a touchscreen, physical buttons, and a microphone. In some embodiments, input may be interpreted from touchscreen gestures, button presses, device motion, and/or commands (verbally spoken). The user interface subsystem may include physical components (e.g., buttons, keyboards, switches, scroll wheels, etc.) or virtualized components (via a touchscreen).

Other user interface subsystem 824 implementations may multiply, combine, further subdivide, augment, and/or subsume the foregoing functionalities within these or other subsystems. For example, the audio input may incorporate elements of the microphone (discussed above with respect to the sensor subsystem). Similarly, IMU based input may incorporate the aforementioned IMU to measure “shakes”, “bumps” and other gestures.

In some embodiments, the user interface subsystem 824 is an integral part of the action device 800. In other embodiments, the user interface subsystem may be augmented by external devices (such as the control device 900, discussed below) and/or removably attached components (e.g., hot-shoe/cold-shoe attachments, etc.) The following sections provide detailed descriptions of the individual components of the sensor subsystem.

### Touchscreen and Buttons Implementation and Design Considerations

In some embodiments, the user interface subsystem 824 may include a touchscreen panel. A touchscreen is an assembly of a touch-sensitive panel that has been overlaid on a visual display. Typical displays are liquid crystal displays (LCD), organic light emitting diodes (OLED), and/or active-matrix OLED (AMOLED). Touchscreens are commonly used to enable a user to interact with a dynamic display, this provides both flexibility and intuitive user interfaces. Within the context of action cameras, touchscreen displays are especially useful because they can be sealed (water-proof, dust-proof, shock-proof, etc.)

Most commodity touchscreen displays are either resistive or capacitive. Generally, these systems use changes in resistance and/or capacitance to sense the location of human finger(s) or other touch input. Other touchscreen technologies may include e.g., surface acoustic wave, surface capacitance, projected capacitance, mutual capacitance, and/or self-capacitance. Yet other analogous technologies may include e.g., projected screens with optical imaging and/or computer-vision.

In some embodiments, the user interface subsystem 824 may also include mechanical buttons, keyboards, switches, scroll wheels and/or other mechanical input devices. Mechanical user interfaces are usually used to open or close a mechanical switch, resulting in an differentiable electrical signal. While physical buttons may be more difficult to seal against the elements, they are nonetheless useful in low-power applications since they do not require an active electrical current draw. For example, many BLE applications may be triggered by a physical button press to further reduce GUI power requirements.

More generally, however, any scheme for detecting user input may be substituted with equal success for any of the foregoing tasks. While the foregoing techniques are described in the context of a touchscreen and physical buttons that enable user data entry, artisans of ordinary skill in the related arts will readily appreciate that any of their derivatives may be substituted with equal success.

### Microphone/Speaker Implementation and Design Considerations

Audio input may incorporate a microphone and codec (discussed above) with a speaker. As previously noted, the microphone can capture and convert audio for voice commands. For audible feedback, the audio codec may obtain audio data and decode the data into an electrical signal. The electrical signal can be amplified and used to drive the speaker to generate acoustic waves.

As previously noted, the microphone and speaker may have any number of microphones and/or speakers for beamforming. For example, two speakers may be used to provide stereo sound. Multiple microphones may be used to collect both the user's vocal instructions as well as the environmental sounds.

### Functional Overview of the Communication Subsystem

Functionally, the communication subsystem may be used to transfer data to, and/or receive data from, external entities. The communication subsystem is generally split into network interfaces and removeable media (data) interfaces. The network interfaces are configured to communicate with other nodes of a communication network according to a communication protocol. Data may be received/transmitted as transitory signals (e.g., electrical signaling over a transmission medium.) The data interfaces are configured to read/write data to a removeable non-transitory computer-readable medium (e.g., flash drive or similar memory media).

The illustrated network/data interface 826 may include network interfaces including, but not limited to: Wi-Fi, Bluetooth, Global Positioning System (GPS), USB, and/or Ethernet network interfaces. Additionally, the network/data interface 826 may include data interfaces such as: SD cards (and their derivatives) and/or any other optical/electrical/magnetic media (e.g., MMC cards, CDs, DVDs, tape, etc.)

### Network Interface Implementation and Design Considerations

The communication subsystem 826 of the action device 800 may include one or more radios and/or modems. In one exemplary embodiment, the radio and modem are configured to communicate over a Bluetooth Low Energy (BLE) network. As used herein, the term “modem” refers to a modulator-demodulator for converting computer data (digital) into a waveform (baseband analog). The term “radio” refers to the front-end portion of the modem that upconverts and/or downconverts the baseband analog waveform to/from the RF carrier frequency.

While the foregoing discussion is presented in the context of Bluetooth Low Energy (BLE) communication networks, artisans of ordinary skill in the related arts will readily appreciate that other communication subsystems may be substituted with equal success (e.g., 5^{th}/6^{th} Generation (5G/6G) cellular networks, Wi-Fi, etc.) Furthermore, the techniques described throughout may be applied with equal success to wired networking devices. Examples of wired communications include without limitation Ethernet, USB, PCI-e. Additionally, some applications may operate within mixed environments and/or tasks. In such situations, the multiple different connections may be provided via multiple different communication protocols. Still other network connectivity solutions may be substituted with equal success.

More generally, any scheme for transmitting data over transitory media may be substituted with equal success for any of the foregoing tasks.

### Data Interface Implementation and Design Considerations

The communication subsystem of the action device 800 may include one or more data interfaces for removeable media. In one exemplary embodiment, the action device 800 may read and write from a Secure Digital (SD) card or similar card memory.

While the foregoing discussion is presented in the context of SD cards, artisans of ordinary skill in the related arts will readily appreciate that other removeable media may be substituted with equal success (flash drives, MMC cards, etc.) Furthermore, the techniques described throughout may be applied with equal success to optical media (e.g., DVD, CD-ROM, etc.).

More generally, any scheme for storing data to non-transitory media may be substituted with equal success for any of the foregoing tasks.

### Functional Overview of the Control and Data Processing Subsystem

Functionally, the control and data processing subsystems are used to read/write and store data to effectuate calculations and/or actuation of the sensor subsystem, user interface subsystem, and/or communication subsystem. While the following discussions are presented in the context of processing units that execute instructions stored in a non-transitory computer-readable medium (memory), other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

As shown in FIG. 8, the control and data subsystem may include one or more of: a central processing unit (CPU 806), an image signal processor (ISP 802), a graphics processing unit (GPU 804), a codec 808, and a non-transitory computer-readable medium 828 that stores program instructions and/or data. Processor units may be multi-core or single core. A single core processor can handle one thread/task at a time; multi-core processors may distribute multiple threads/tasks among its cores.

### Processor-Memory Implementations and Design Considerations

As a practical matter, different processor architectures attempt to optimize their designs for their most likely usages. More specialized logic can often result in much higher performance (e.g., by avoiding unnecessary operations, memory accesses, and/or conditional branching). For example, a general-purpose CPU (such as shown in FIG. 8) may be primarily used to control device operation and/or perform tasks of arbitrary complexity/best-effort. CPU operations may include, without limitation: general-purpose operating system (OS) functionality (power management, UX), memory management, etc. Typically, such CPUs are selected to have relatively short pipelining, longer words (e.g., 32-bit, 64-bit, and/or super-scalar words), and/or addressable space that can access both local cache memory and/or pages of system virtual memory. More directly, a CPU may often switch between tasks, and must account for branch disruption and/or arbitrary memory access.

In contrast, the image signal processor (ISP) performs many of the same tasks repeatedly over a well-defined data structure. Specifically, the ISP maps captured camera sensor data to a color space. ISP operations often include, without limitation: demosaicing, color correction, white balance, and/or autoexposure. Most of these actions may be done with scalar vector-matrix multiplication. Raw image data has a defined size and capture rate (for video) and the ISP operations are performed identically for each pixel; as a result, ISP designs are heavily pipelined (and seldom branch), may incorporate specialized vector-matrix logic, and often rely on reduced addressable space and other task-specific optimizations. ISP designs only need to keep up with the camera sensor output to stay within the real-time budget; thus, ISPs more often benefit from larger register/data structures and do not need parallelization. In many cases, the ISP may locally execute its own real-time operating system (RTOS) to schedule tasks of according to real-time constraints.

Much like the ISP, the GPU is primarily used to modify image data and may be heavily pipelined (seldom branches) and may incorporate specialized vector-matrix logic. Unlike the ISP however, the GPU often performs image processing acceleration for the CPU, thus the GPU may need to operate on multiple images at a time and/or other image processing tasks of arbitrary complexity. In many cases, GPU tasks may be parallelized and/or constrained by real-time budgets. GPU operations may include, without limitation: stabilization, lens corrections (stitching, warping, stretching), image corrections (shading, blending), noise reduction (filtering, etc.). GPUs may have much larger addressable space that can access both local cache memory and/or pages of system virtual memory. Additionally, a GPU may include multiple parallel cores and load balancing logic to e.g., manage power consumption and/or performance. In some cases, the GPU may locally execute its own operating system to schedule tasks according to its own scheduling constraints (pipelining, etc.).

The hardware codec converts image data to an encoded data for transfer and/or converts encoded data to image data for playback. Much like ISPs, hardware codecs are often designed according to specific use cases and heavily commoditized. Typical hardware codecs are heavily pipelined, may incorporate discrete cosine transform (DCT) logic (which is used by most compression standards), and often have large internal memories to hold multiple frames of video for motion estimation (spatial and/or temporal). As with ISPs, codecs are often bottlenecked by network connectivity and/or processor bandwidth, thus codecs are seldom parallelized and may have specialized data structures (e.g., registers that are a multiple of an image row width, etc.). In some cases, the codec may locally execute its own operating system to schedule tasks according to its own scheduling constraints (bandwidth, real-time frame rates, etc.).

Other processor subsystem implementations may multiply, combine, further subdivide, augment, and/or subsume the foregoing functionalities within these or other processing elements. For example, multiple ISPs may be used to service multiple camera sensors. Similarly, codec functionality may be subsumed with either GPU or CPU operation via software emulation.

In one embodiment, the memory subsystem may be used to store data locally at the action device 800. In one exemplary embodiment, data may be stored as non-transitory symbols (e.g., bits read from non-transitory computer-readable mediums.) In one specific implementation, the memory subsystem 828 is physically realized as one or more physical memory chips (e.g., NAND/NOR flash) that are logically separated into memory data structures. The memory subsystem may be bifurcated into program code 830 and/or program data 832. In some variants, program code and/or program data may be further organized for dedicated and/or collaborative use. For example, the GPU and CPU may share a common memory buffer to facilitate large transfers of data therebetween. Similarly, the codec may have a dedicated memory buffer to avoid resource contention.

In some embodiments, the program code may be statically stored within the action device 800 as firmware. In other embodiments, the program code may be dynamically stored (and changeable) via software updates. In some such variants, software may be subsequently updated by external parties and/or the user, based on various access permissions and procedures.

### Generalized Operation of the Action Device

In one embodiment, the non-transitory computer-readable medium includes a routine that enables fast wake-up via virtual action address. When executed by the control and data subsystem, the routine causes the action device to: provide a virtual action address, enter a standby mode, receive a request via the virtual action address, and process an interrupt corresponding to the virtual action address. These steps are discussed in greater detail below.

At step 842, the action device provides a virtual action address to a control device. In one embodiment, the action device creates a new network, or enters a pre-existing network. As part of the network enumeration process, the action device may request or be assigned a number of network addresses. In one exemplary embodiment, the action device is allocated surplus addresses; in one specific implementation, the surplus addresses are reserved-for, or assigned-to one or more actions. In some embodiments, the actions may be pre-defined or otherwise static. In other embodiments, the actions may be dynamically assigned.

While the foregoing discussion is presented in the context of network addresses corresponding to network endpoints, virtually any addressable modality may be substituted with equal success. For example, an action device may expose an addressable range of memory (including a virtual action memory map) that is accessible to other network devices (such as may be used in PCI-e style networks). In other examples, an action device may be enumerated as multiple unique identifiers which may be used by the other devices of the network (such as may be used in USB-style networks).

In one embodiment, the action device discovers one or more other devices of the network; or alternatively, the action device may be discovered by one or more other devices of the network. In one exemplary embodiment, the action device and at least one other device negotiate a persistent association. Here, a “persistent” association refers to an association that persists after a connection has ceased. For example, BLE pairing/bonding persists even after an active BLE connection has ended.

In one embodiment, the action device configures the virtual action address to trigger a resulting action; the combination of virtual action address and action is provided to the other device (the control device). In one embodiment, the control device is granted privilege to trigger the action, based on the determined persistent relationship. For example, BLE white lists may be used to verify that only previously paired/bonded endpoints may re-connect. Other access control schemes may be substituted with equal success (e.g., address masking, address filtering, content filtering, black lists, etc.)

In some embodiments, the action device can be used to limit the nature and/or extent of actions. For example, certain actions may only be permissible under certain circumstances e.g., fast wake may only be active during a low-power mode/suspended operation, otherwise the conventional network addressing may be required. In other examples, action device may prioritize its own actions over the exposed actions (e.g., the action device's locally triggered captures cannot be preempted for a remote capture, etc.). Still other embodiments may allow the control device to specify the limitations and/or restrictions of the action device operation. This may be particularly useful where the smart phone is used to configure the action camera from a distance, without direct access to the camera itself.

While various embodiments are described in the context of an established pairing/bonding relationship, artisans of ordinary skill in the related arts will readily appreciate that other networks implement trusted relationships on a larger scale than pairwise couplings. For example, zero-trust networks can safely permit certain classes of device interactions, regardless of previous interaction (since all network transactions are treated anonymously).

Furthermore, while the various techniques use previous association to prevent malicious activity/misuse, less rigorous associations (even anonymous) may be permitted where such concerns are not unimportant or otherwise secondary. For example, secure closed networks may expose virtual action addresses to any network entity, etc.

At step 844, the action device enters a standby mode. In one embodiment, the primary processing components of the action device may transition to a low-power/unpowered state; in one specific implementation, only a low-power modem periodically checks for network activity (e.g., BLE scanning).

While the foregoing discussion is described in the context of a standby mode that is not immediately unavailable for image capture, a variety of other scenarios may result in unavailable resources (or similar unresponsive behavior). For example, some devices may reduce power to non-critical memory and/or processing components which result in hidden bottlenecks. In other examples, devices may over-subscribe their processing capabilities (i.e., the processor is unavailable because it is too busy). Still other implementations may already be reserved for other devices on the network; e.g., an action camera may already be streaming data to a laptop via its general-purpose OS, and cannot immediately context-switch to service a smart phone request, etc.

More generally, the techniques described throughout may apply to any situation where some (but not all) resources of the action device are rendered unavailable.

At step 846, the action device receives a connection request via the virtual action address, and in response processes an interrupt based on the virtual action address (step 848).

In one embodiment, the action execution may be performed in parallel with another process. For example, an action device with a first set of cores may perform a boot sequence (the interrupted thread(s)), while allowing a second set of cores to concurrently schedule an image capture (the triggered action).

In one embodiment, the action execution may preempt another process. Consider a scenario where an action device with a primary CPU may be mid/late-boot sequence. Instead of continuing with its run-level applications according to its start-up sequence (the preempted thread(s)), the CPU may quickly service a momentary action such as an image capture (the triggered action).

In one embodiment, the action execution may be performed in lieu of another process. For example, an action device with a primary CPU may perform a boot sequence (the terminated thread(s)); however, the virtual action address may trigger an alternative boot sequence (the triggered action). In this implementation, the default boot sequence may actually be wholly restarted.

While the foregoing actions are presented in the context of an action camera that enables fast wake-up for e.g., image capture, video capture, video stop and encode, those of ordinary skill in the related arts will readily appreciate that the actions may be broadly extended to many different use cases. Examples of actions might include e.g., starting a process, ending a process, capturing data, reporting data, encoding data, etc. Within the context of action cameras, some particularly useful actions may entail capturing media (audio, video, images), encoding media, stitching media, streaming media, archiving media, and/or otherwise processing media.

### Functional Overview of the Control Device

Functionally, a “control device” 900 refers to a device that can access a virtual action address via a communication network, to trigger an action at another device. As a practical matter, the control device may need to pre-configure the action and/or other operational parameters.

The control device has many similarities in operation and implementation to the action device which are not further discussed; the following discussion provides a discussion of the internal operations, design considerations, and/or alternatives, that are specific to control device operation.

FIG. 9 is a logical block diagram of an exemplary control device 900. The control device 900 includes: a user interface subsystem, a communication subsystem, a control and data subsystem, and a bus to enable data transfer. The following discussion provides a specific discussion of the internal operations, design considerations, and/or alternatives, for each subsystem of the exemplary control device 900.

### Functional Overview of the User Interface Subsystem

Functionally, the user interface subsystem 924 may be used to present media to, and/or receive input from, a human user. Media may include any form of audible, visual, and/or haptic content for consumption by a human. Examples include images, videos, sounds, and/or vibration. Input may include any data entered by a user either directly (via user entry) or indirectly (e.g., by reference to a profile or other source).

The illustrated user interface subsystem 924 may include: a touchscreen, physical buttons, and a microphone. In some embodiments, input may be interpreted from touchscreen gestures, button presses, device motion, and/or commands (verbally spoken). The user interface subsystem may include physical components (e.g., buttons, keyboards, switches, scroll wheels, etc.) or virtualized components (via a touchscreen).

### User Interface Subsystem Considerations for Different Device Types

While the foregoing discussions have been presented within the context of a smart phone, a variety of other devices are commonly used in the mobile device ecosystem including without limitation: laptops, tablets, smart phones, smart watches, smart glasses, and/or other electronic devices. These different device-types often come with different user interfaces and/or capabilities.

In laptop embodiments, user interface devices may include both keyboards, mice, touchscreens, microphones and/speakers. Laptop screens are typically quite large, providing display sizes well more than 2K (2560×1440), 4K (3840×2160), and potentially even higher. In many cases, laptop devices are less concerned with outdoor usage (e.g., water resistance, dust resistance, shock resistance) and often use mechanical button presses to compose text and/or mice to maneuver an on-screen pointer.

In terms of overall size, tablets are like laptops and may have display sizes well more than 2K (2560×1440), 4K (3840×2160), and potentially even higher. Tablets tend to eschew traditional keyboards and rely instead on touchscreen and/or stylus inputs.

Smart phones are smaller than tablets and may have display sizes that are significantly smaller, and non-standard. Common display sizes include e.g., 2400×1080, 2556×1179, 2796×1290, etc. Smart phones are highly reliant on touchscreens but may also incorporate voice inputs. Virtualized keyboards are quite small and may be used with assistive programs (to prevent mis-entry).

Smart watches and smart glasses have not had widespread market adoption but will likely become more popular over time. Their user interfaces are currently quite diverse and highly subject to implementation.

### Functional Overview of the Communication Subsystem

Functionally, the communication subsystem may be used to transfer data to, and/or receive data from, external entities. The communication subsystem is generally split into network interfaces and removeable media (data) interfaces. The network interfaces are configured to communicate with other nodes of a communication network according to a communication protocol. Data may be received/transmitted as transitory signals (e.g., electrical signaling over a transmission medium.) In contrast, the data interfaces are configured to read/write data to a removeable non-transitory computer-readable medium (e.g., flash drive or similar memory media).

The illustrated network/data interface 926 may include network interfaces including, but not limited to: Wi-Fi, Bluetooth, Global Positioning System (GPS), USB, and/or Ethernet network interfaces. Additionally, the network/data interface subsystem 826 may include data interfaces such as: SD cards (and their derivatives) and/or any other optical/electrical/magnetic media (e.g., MMC cards, CDs, DVDs, tape, etc.)

### Functional Overview of the Control and Data Processing Subsystem

Functionally, the control and data processing subsystems are used to read/write and store data to effectuate calculations and/or actuation of the user interface subsystem, and/or communication subsystem. While the following discussions are presented in the context of processing units that execute instructions stored in a non-transitory computer-readable medium (memory), other forms of control and/or data may be substituted with equal success, including e.g., neural network processors, dedicated logic (field programmable gate arrays (FPGAs), application specific integrated circuits (ASICs)), and/or other software, firmware, and/or hardware implementations.

As shown in FIG. 9, the control and data subsystem may include one or more of: a central processing unit (CPU 906), a graphics processing unit (GPU 904), a codec 908, and a non-transitory computer-readable medium 928 that stores program instructions and/or data.

### Generalized Operation of the Control Device

In one embodiment, the non-transitory computer-readable medium includes a routine that requests actions via virtual action addresses. When executed by the control and data subsystem, the routine causes the control device to: obtain a virtual action address, enter a standby mode, receive a user input, and transmit a connection request to cause fast wake-up and action execution. These steps are discussed in greater detail below.

At step 942, the control device obtains a virtual action address from an action device. As previously discussed, the control device and action device may negotiate a persistent association and/or limit the nature and/or extent of actions. In some cases, the control device may need to consider its own capabilities and/or limitations when configuring the actions. For example, real-time responses from the action device may need to be handled according to the control device's own capabilities without the benefit of flow control (since the action device may not have a functional OS).

Additionally, the control device may need to manage its other connected devices. For example, a laptop may be paired with multiple other devices (each of which may have their own individual requirements). In some cases, the control device may need to assess and/or manage the activity and/or resources remotely.

In some embodiments, the control device may take an active role in configuring the action device's triggered action. For example, the control device may allow a user to dynamically configure the action processing using a drag-and-drop-style macro programming GUI.

At step 944, the control device enters a standby mode. In one embodiment, the primary processing components of the control device may transition to a low-power/unpowered state; in one specific implementation, only a low-power modem periodically checks for network activity (e.g., BLE scanning).

At step 946, the control device receives a user input that can be handled by the action device; in response, it transmits a connection request that causes the fast wake-up and action execution (step 948).

### Functional Overview of the Communication Network

As used herein, a “communication network” 1000 refers to an arrangement of logical nodes that enables data communication between endpoints (an endpoint is also a logical node). Each node of the communication network may be addressable by other nodes; typically, a unit of data (a data packet) may be traverse across multiple nodes in “hops” (a segment between two nodes). Functionally, the communication network enables active participants (e.g., action devices and/or control devices) to communicate with one another. In some implementations, the communication network may also differentiate between network addresses (with a unique network node) and virtual addresses (without a unique node).

### Communication Networks, Implementation and Design Considerations

While the present disclosure discusses an ad hoc communication network's role for action devices and control devices, other systems may use more permanent communication network technologies (e.g., Bluetooth BR/EDR, Wi-Fi, 5G/6G cellular networks, etc.). For example, an action camera may use a Wi-Fi network to stream media to a smart phone. In other examples, the action camera may use a cellular network to stream media to a remote node over the Internet. In these examples, the action camera may be pre-occupied with streaming media but may still be able to accept instructions via a virtual action address. These technologies are briefly discussed below.

So-called 5G cellular network standards are promulgated by the 3^{rd} Generation Partnership Project (3GPP) consortium. The 3GPP consortium periodically publishes specifications that define network functionality for the various network components. For example, the 5G system architecture is defined in 3GPP TS 23.501 (System Architecture for the 5G System (5GS), version 17.5.0, published Jun. 15, 2022; incorporated herein by reference in its entirety). As another example, the packet protocol for mobility management and session management is described in 3GPP TS 24.501 (Non-Access-Stratum (NAS) Protocol for 5G System (5G); Stage 3, version 17.5.0, published Jan. 5, 2022; incorporated herein by reference in its entirety).

Currently, there are three main application areas for the enhanced capabilities of 5G. They are Enhanced Mobile Broadband (eMBB), Ultra Reliable Low Latency Communications (URLLC), and Massive Machine Type Communications (mMTC).

Enhanced Mobile Broadband (eMBB) uses 5G as a progression from 4G LTE mobile broadband services, with faster connections, higher throughput, and more capacity. eMBB is primarily targeted toward traditional “best effort” delivery (e.g., smart phones); in other words, the network does not provide any guarantee that data is delivered or that delivery meets any quality of service. In a best-effort network, all users obtain best-effort service such that the overall network is resource utilization is maximized. In these network slices, network performance characteristics such as network delay and packet loss depend on the current network traffic load and the network hardware capacity. When network load increases, this can lead to packet loss, retransmission, packet delay variation, and further network delay, or even timeout and session disconnect.

Ultra-Reliable Low-Latency Communications (URLLC) network slices are optimized for “mission critical” applications that require uninterrupted and robust data exchange. URLLC uses short-packet data transmissions which are easier to correct and faster to deliver. URLLC was originally envisioned to provide reliability and latency requirements to support real-time data processing requirements, which cannot be handled with best effort delivery.

Massive Machine-Type Communications (mMTC) was designed for Internet of Things (IoT) and Industrial Internet of Things (IIoT) applications. mMTC provides high connection density and ultra-energy efficiency. mMTC allows a single GNB to service many different devices with relatively low data requirements.

Wi-Fi is a family of wireless network protocols based on the IEEE 802.11 family of standards. Like Bluetooth, Wi-Fi operates in the unlicensed ISM band, and thus Wi-Fi and Bluetooth are frequently bundled together. Wi-Fi also uses a time-division multiplexed access scheme. Medium access is managed with carrier sense multiple access with collision avoidance (CSMA/CA). Under CSMA/CA. During Wi-Fi operation, stations attempt to avoid collisions by beginning transmission only after the channel is sensed to be “idle”; unfortunately, signal propagation delays prevent perfect channel sensing. Collisions occur when a station receives multiple signals on a channel at the same time and are largely inevitable. This corrupts the transmitted data and can require stations to re-transmit. Even though collisions prevent efficient bandwidth usage, the simple protocol and low cost has greatly contributed to its popularity. As a practical matter, Wi-Fi access points have a usable range of ˜50 ft indoors and are mostly used for local area networking in best-effort, high throughput applications.

### Technological Improvements and Other Considerations

The above-described system and method solves a technological problem in industry practice related to boot sequencing and/or wake-up from low-power. The various solutions described herein directly address a problem that is created by limitations of most general-purpose operating systems in multi-processor devices. Specifically, the entire device may be rendered unavailable for processing during boot events, even though some processing resources could be used to service short term requests. Various aspects of the present disclosure resolve this by allowing the real-time operating system of the supplemental processing resources to service connection requests in a limited manner. This provides a short-term solution, until the general-purpose operating system has completed its boot sequence.

As a related consideration, existing techniques for system boot is monolithic in nature. For example, previous solutions rely on a single boot sequence that must sequentially complete for the CPU before enabling operation with e.g., the GPU, ISP, etc. In most cases, these components are designed to operate with minimal supervision (e.g., the ISP does not require any input from the CPU to capture an image). The various solutions described herein enable faster response times out of low-power modes, which also improves power consumption. In other words, the techniques described herein represent an improvement to the field of embedded computing environments.

### Additional Configuration Considerations

Throughout this specification, some embodiments have used the expressions “comprises,” “comprising,” “includes,” “including,” “has,” “having” or any other variation thereof, all of which are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

As used herein any reference to any of “one embodiment” or “an embodiment”, “one variant” or “a variant”, and “one implementation” or “an implementation” means that a particular element, feature, structure, or characteristic described in connection with the embodiment, variant or implementation is included in at least one embodiment, variant, or implementation. The appearances of such phrases in various places in the specification are not necessarily all referring to the same embodiment, variant, or implementation.

As used herein, the term “computer program” or “software” is meant to include any sequence of human or machine cognizable steps which perform a function. Such program may be rendered in virtually any programming language or environment including, for example, Python, JavaScript, Java, C#/C++, C, Go/Golang, R, Swift, PHP, Dart, Kotlin, MATLAB, Perl, Ruby, Rust, Scala, and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM. PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die or distributed across multiple components.

As used herein, the terms “camera” or “image capture device” may be used to refer without limitation to any imaging device or sensor configured to capture, record, and/or convey still and/or video imagery, which may be sensitive to visible parts of the electromagnetic spectrum and/or invisible parts of the electromagnetic spectrum (e.g., infrared, ultraviolet), and/or other energy (e.g., pressure waves).

Upon reading this disclosure, those of skill in the art will appreciate still additional alternative structural and functional designs as disclosed from the principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A capture apparatus, comprising:
a camera sensor;
a network interface;
a first processor core;
a second processor core; and
a first non-transitory computer-readable medium comprising a first set of instructions that when executed by the first processor core, causes the first processor core to:
provide a virtual action address to a control device;
configure the network interface to scan for a connection request to the virtual action address;
enter a standby mode; and
a second non-transitory computer-readable medium comprising a second set of instructions that when executed by the first processor core, causes the first processor core to:
service an action associated with the virtual action address.

2. The capture apparatus of claim 1, where the connection request to the virtual action address causes a wake event.

3. The capture apparatus of claim 2, where the first set of instructions, further causes the first processor core to boot a general purpose-operating system on the wake event.

4. The capture apparatus of claim 2, where the first set of instructions, further causes the second processor core to resume a real-time operating system on the wake event.

5. The capture apparatus of claim 4, where the action comprises one or more threads to capture an image.

6. The capture apparatus of claim 4, where the action comprises one or more threads to capture a video.

7. The capture apparatus of claim 1, further where the first set of instructions, further causes the first processor core to transfer re-connection information to the control device.

8. The capture apparatus of claim 7, further where the re-connection information comprises pairing and bonding keys.

9. A method for fast wake-up via virtualized addresses, comprising:
providing a virtual action address to a control device;
configure a network interface to scan for a connection request to the virtual action address;
entering a standby mode and periodically scanning for the connection request to the virtual action address; and
responsive to receiving the connection request, servicing an action associated with the virtual action address.

10. The method of claim 9, where the action is serviced by a first processor core; and
responsive to receiving the connection request, booting a general-purpose operating system with a second processor core.

11. The method of claim 10, where the action comprises capturing an image or a video while booting the general-purpose operating system.

12. The method of claim 11, further comprising transferring the image or the video via the general-purpose operating system.

13. The method of claim 9, further comprising generating a network address according to a generic attribute (GAT) profile of a Bluetooth Low Energy protocol.

14. The method of claim 13, further comprising serving the network address according to a generic access attribute (GAP) profile of the Bluetooth Low Energy protocol.

15. A control apparatus, comprising:
a network interface;
a processor core; and
a non-transitory computer-readable medium comprising a set of instructions that when executed by the processor core, causes the processor core to:
obtain a virtual action address and a network address from an action device;
transmit a first connection request to the virtual action address to cause the action device to capture an image; and
transmit a second connection request to the network address to request the image.

16. The control apparatus of claim 15, where the set of instructions causes the processor core to pair and bond to the action device via at least the network address.

17. The control apparatus of claim 16, where at least one cryptographic key is shared between the virtual action address and the network address.

18. The control apparatus of claim 16, where the virtual action address and the network address have different cryptographic keys.

19. The control apparatus of claim 16, where the first connection request is sent while the action device is in a sleep mode.

20. The control apparatus of claim 16, where the second connection request is sent after the action device has completed a boot sequence.
